(19) United States
(12) Patent Application Publication
(10) Pub. No.: US 2021/0023404 A1
(43) Pub. Date: Jan. 28, 2021

(54) CHAR Fire Fighting, Climbing and Demolition Hook

(71) Applicants: Nathan Erwin, Royal Oak, MI (US); Frederick Galvin, East China, MI (US)

(72) Inventors: Nathan Barrett Erwin, Royal Oak, MI (US); Frederick William Galvin, East China, MI (US)

(21) Appl. No.: 16/523,866

(22) Filed: Jul. 26, 2019

(51) Int. Cl. A62C 8/00; E04G 23/08

(52) U.S. Cl. CPC A62C 8/00; B66F 15/00; E04G 23/08

(57) ABSTRACT

The CHAR (Climb, Hook And Rip) is a multipurpose tool used by interior structural firefighters to accomplish common essential tasks such as pulling down ceilings, and breaching walls. In addition, it facilitates a quick advancement into the attic of a structure to extinguish fire extension. The innovation is that the CHAR's unique head secures the tool to dimensional 2″ lumber, common to wood framed dwelling structures. The head allows an interior firefighter to hook floor and ceiling joists and climb the tool itself to reach another level of the structure. Most likely the tool is used to rip down the ceiling, hook the ceiling joist and climb up to the attic. In a worst-case scenario such as a firefighter falling through the floor, the firefighter may be able to hook a floor joist and climb up the tool to self-rescue.

### CROSS REFERENCE

Provisional patent application No. 62/713,999

Filing Date of Aug. 2, 2018

Title: Firefighting tool that hooks the ceiling joist then is used to climb

### BACKGROUND

There is an inherent danger to fighting structure fires. One of the worst possible scenarios a firefighter could encounter inside of a structure fire is falling through a burnt-out floor. Even if the firefighter stays conscious, it is incredibly difficult for a firefighter in full gear to pull themselves up and out of a collapsed hole in a floor. We recognized the need for a firefighter to have a tool they could use to vertically rescue themselves in the unforeseen event that they fall through a collapsed floor. Time is crucial during a fire emergency, therefore for this tool to be practical, a firefighter would need to be already using it for normal firefighting operations the same they would use axes and pike poles. The CHAR Fire Fighting, Climbing and Demolition Hook can be used for pulling down ceilings and walls to expose fire extension in wall and void spaces within a structure, but it can also be used to assist firefighters in climbing up out of collapsed floors or into attics and cocklofts.

There is a traditional firefighter ladder known as a Pompier ladder which has been used in the fire service since the late 1800s. This type of ladder is not often used in the modern fire service, but it is still well known by the men and women in the field today. The ladder is a pole type ladder with a large hook on the end (see FIG. 7). A firefighter would use this ladder from the exterior of the building to smash through the windows of the story above and hook it to the windowsill. The firefighter can then climb up to the story above. There are other pole type tools with hooks such as pike poles used in firefighting; these tools are used to pull down drywall, lath and plaster, and various other building materials in order to search inside walls and ceilings for fire extension. The CHAR Fire Fighting, Climbing and Demolition Hook utilizes some of the principles of the Pompier ladder but is its unique designed is specifically suited for use in the interior of a structure fire and to attach to wood ceiling joists. Wood framed structures are one of the most common construction types in the United States, therefore, many of the dwelling, and commercial building fires fought by firefighters are in these types of structures.

The CHAR Fire Fighting, Climbing and Demolition Hook is a 6.5 foot tall combination tool that is best suited for fighting fires within wood framed structures. It uses the principle of a pole ladder with the added benefit of a pointed demolition hook which can be used in the interior of the structure to break through walls and ceilings. Furthermore, the top head of the tool is specifically designed to hook and grip down on dimensional 2-inch-thick ceiling joists so the tool can be used to climb to the floor above in the event a firefighter finds themselves in a situation they need to.

### SUMMARY

The CHAR Fire Fighting, Climbing and Demolition Hook is a 6′5″ pole with a sharpened head and a hook designed to grip to 2-inch dimensional lumber (see FIG. 1). The actual width of modern 2-inch dimensional lumber is 1½ inch thick; the tool's design allows it to attach to both traditional 2-inch thick dimensional lumber and modern 1½ inch thick dimensional lumber.

There are two rows of serrated metal teeth on the hook directed toward the pole, and a single row of serrated metal teeth on the pole directed toward the hook, these are designed to grip the sides and top of 2-inch dimensional lumber and secure the tool in the desired position/area. In addition, the CHAR Fire Fighting, Climbing and Demolition Hook has three pegs welded to its pole, the pegs are 18 inches apart on alternating sides designed as either foot pegs to climb the tool, or hand pegs to hold while pulling down ceilings and walls.

The CHAR Firefighting, Climbing and Demolition Hook is a manually operated tool used for breaking through various building construction materials such as wood, lathe and plaster, drywall, shingles, etcetera, but it can also be used to climb to a floor above during normal fire procedures, and during emergency situations (self-rescue). The innovation of the tool is that it not only hooks onto the top of a ceiling joist, but that it grips down on the sides of the joist to secure the tool in place and to prevent it from slipping off. The specific size and angle of the hook and the serrated teeth grip down tighter on the wood joist as the firefighter applies their body weight and force onto the tool (see FIG. 4, 5, 6)

### DESCRIPTION OF DRAWINGS AND PHOTOGRAPH ATTACHMENTS

FIG. 1. The CHAR Fire Fighting, Climbing and Demolition Hook full tool dimensions. This is an image of the entire tool.

FIG. 2. CHAR Fire Fighting, Climbing and Demolition Hook head design and dimensions. This is the specifications of the head design

FIG. 3. Top head and serrated teeth. CHAR Fire Fighting, image of the head showing the two rows of serrated teeth welded to the side of the drop-down snoot.

FIG. 4. Attached to ceiling joist. Image of the CHAR Fire Fighting, Climbing and Demolition Hook attached to a ceiling joist and a firefighter climbing up.

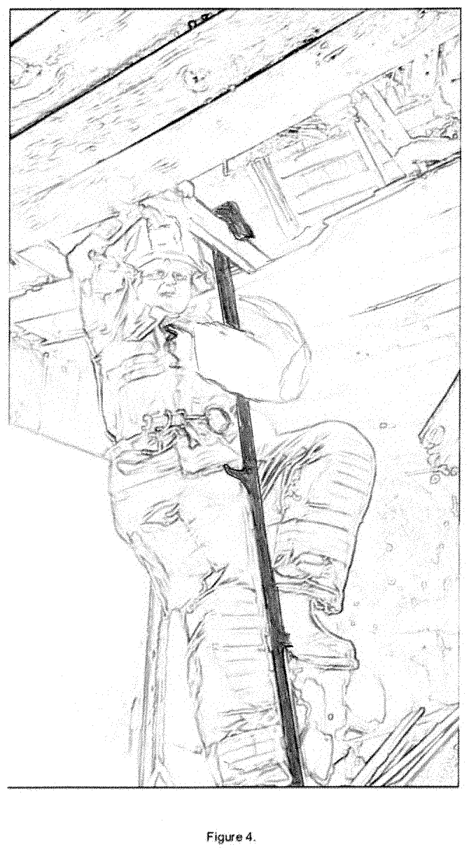

FIG. 5. Bottom view of a firefighter using the CHAR Fire Fighting, Climbing and Demolition Hook to climb up through a ceiling scuttle attic access.

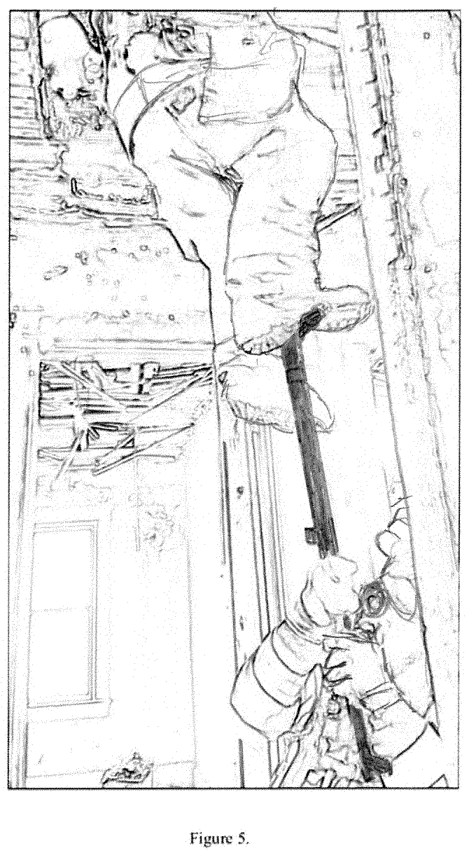

FIG. 6. Firefighter climbing up through scuttle hole. Top view of firefighter using the CHAR Fire Fighting, Climbing and Demolition Hook to climb up through an attic scuttle access.

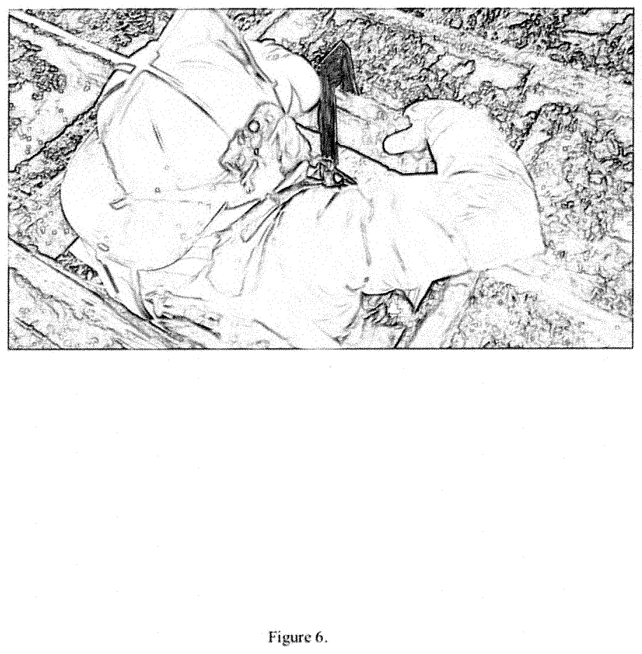

FIG. 7. Historical photographs of the Firefighter Pompier ladder. The images in this attachment are historical photographs of firefighters using a pompier ladder to climb up the exterior of a building from window to window.

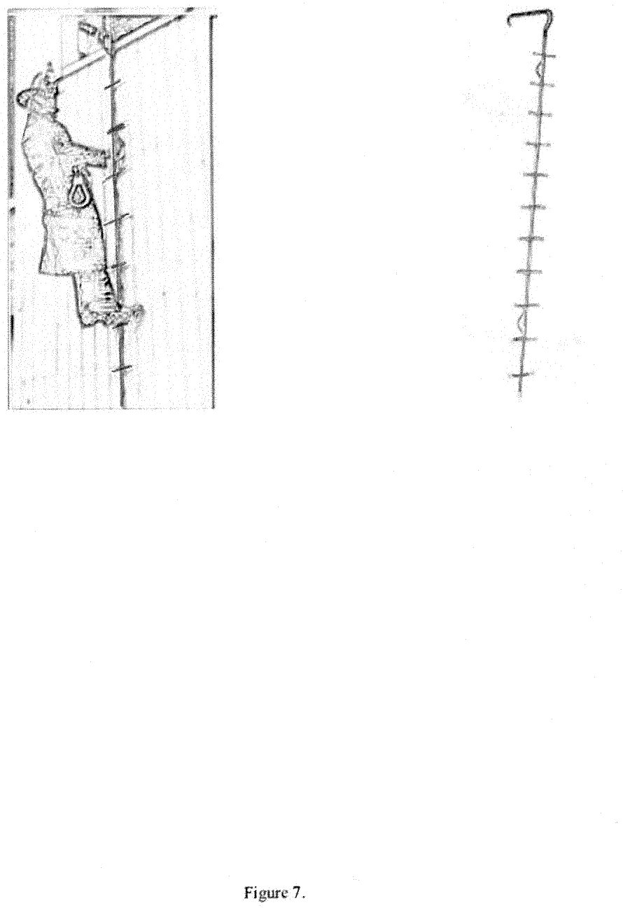

### DETAILED DESCRIPTION OF THE INVENTION

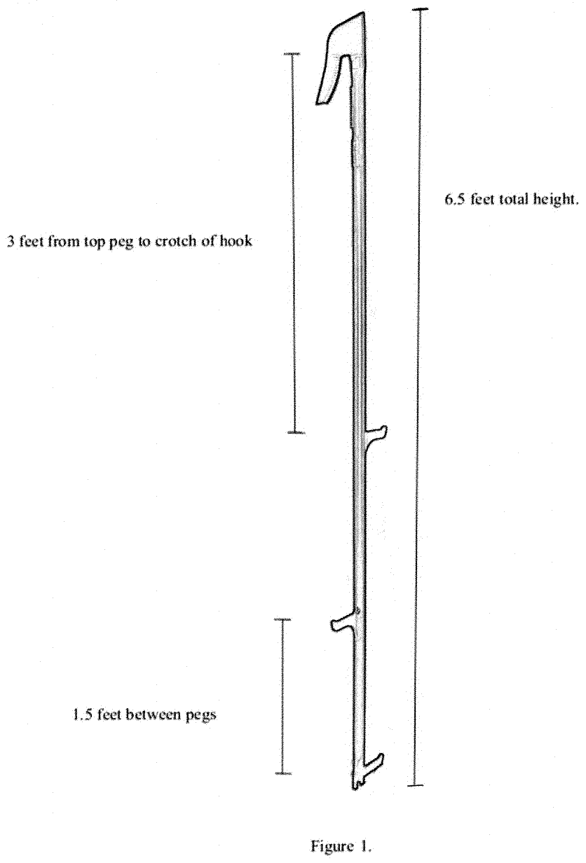

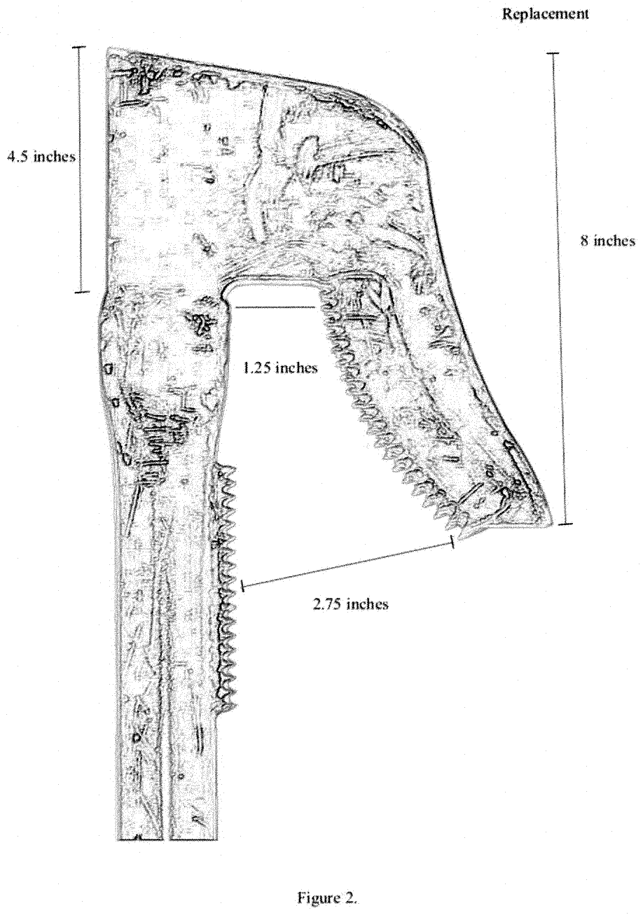

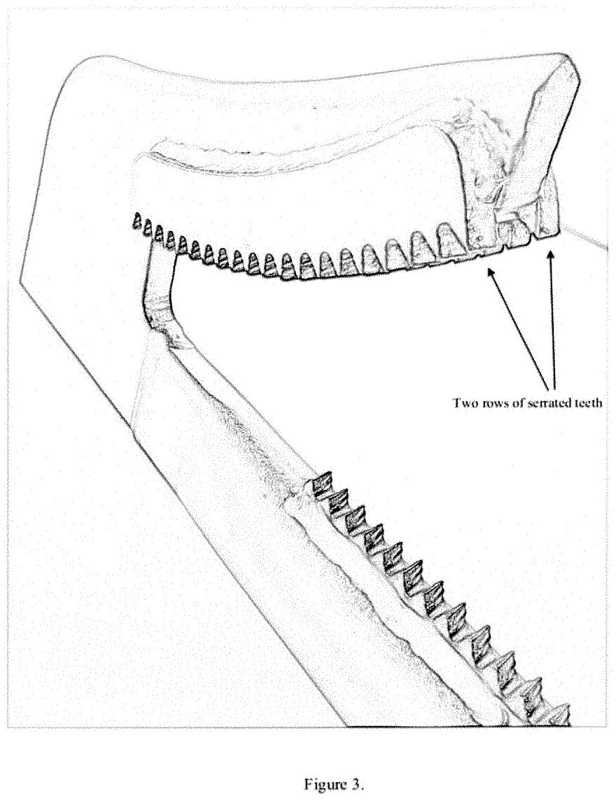

The CHAR Fire Fighting, Climbing and Demolition Hook is 6.5 feet long tool constructed entirely of steel with each component welded to the tool (see FIG. 1). There is a 6-foot-long pole which is 1¼ inches in diameter. On top of the pole there is a ⅜-inch-thick head that extends 4 inches to a sharpened point (see FIG. 2). The head is 4 inches wide with a portion that drops down 5 inches angling away from the pole, creating the hook. The hook has two rows of ¼ inch thick serrated teeth. One row of teeth is welded to each side of the hook (see FIG. 3). The pole has a single row of ¼ inch serrated teeth, located 3 inches down from the top of the pole were the head is inserted and welded to the pole. The bottom opening of the hook is 2% inch-wide and reduces to a 1¼ wide at the top of the hook opening. There are two 4-inch-long, 1-inch-wide and ⅜-inch-thick metal pegs that are welded to the pole area; and one 4-inch-long, 1-inch-wide and ⅜-inch-thick metal peg that is inserted and welded to the base of the pole. This lowest/first peg has a two prong % inch long fork at the bottom. The other two pegs are welded to the pole on alternating sides 18 inches apart. The second peg is 18 inches from the bottom, and the third peg is 36 inches from the bottom. cm 1: The CHAR Fire Fighting, Climbing and Demolition Hook is a 6.5 foot multipurpose tool designed for firefighters to (1) manually break through building materials such as dry wall, lath and plaster, or wood; and (2) to hook and attach the tool onto a wood floor or ceiling joist in order to climb up the tool to the level above.

2: The head of the tool is designed with a point at the top to break through various building material and with a downward sweeping hook that grips onto floor and ceiling joists. The bottom opening of the hook is 2¾ inch wide and reduces to a 1¼ wide. There are two rows of serrated teeth welded to the inside of the downward hook. The hook's designed allows a firefighter to attach the tool to a 2-inch thick dimensional lumber; the hook tightens and its teeth dig in deeper into the lumber as force and weight are apply downward to the pegs of the tool.
